(19) United States
(12) Patent Application Publication
(10) Pub. No.: US 2014/0319418 A1
(43) Pub. Date: Oct. 30, 2014

(54) PROCESS FOR PRODUCING HYDROGELS

(71) Applicants: Zhizhong Cai, Limburgerhof (DE); Shane Mc Donnell, Lyon (FR); Burkhard Walther, Garching (DE)

(72) Inventors: Zhizhong Cai, Limburgerhof (DE); Shane Mc Donnell, Lyon (FR); Burkhard Walther, Garching (DE)

(73) Assignee: CONSTRUCTION RESEARCH AND TECHNOLOGY GmbH, Trostberg (DE)

(21) Appl. No.: 14/008,757

(22) PCT Filed: Apr. 13, 2012
(86) PCT No.: PCT/IB2012/051813

§ 371 Date: Nov. 15, 2013

(30) Foreign Application Priority Data
Apr. 29, 2011 (EP) 11164250.0

(51) Int. Cl. C01B 33/154; C01B 33/157

(52) U.S. Cl. CPC C01B 33/154; C01B 33/157
USPC 252/182.32; 423/335; 422/232

(57) ABSTRACT

The invention relates to a process for producing a hydrogel, which is performed in a reactor which has a body A which rotates about an axis of rotation and a metering system. A component comprising at least i) a soluble salt of an acidic or amphoteric oxygen-containing molecular anion and ii) a component comprising a precipitant are applied with the aid of the metering system to the surface of the rotating body A, such that a mixture of components i) and ii) flows over the surface of the rotating body A to an outer region of the surface of the rotating body A, the mixture leaves the surface and the pH of the mixture after leaving the surface of the body A is between 2 and 12. Additionally disclosed is the use of the resulting hydrogels for production of aerogels.

The invention relates to a process for producing hydrogels based on a soluble salt of an acidic or amphoteric oxygen-containing molecular anion. Additionally disclosed is the use of the hydrogels for production of aerogels.

Aerogels are high-porosity solids in which up to 99.98% of the volume consists of pores. Aerogels can be produced on the basis of various materials, silica aerogels being the most well-known. However, they can also be formed from other acidic or amphoteric oxygen-containing molecular anions, for example titanates or aluminates.

Aerogels can be obtained in this case especially via a sol-gel process to form a hydrogel, and subsequent drying. The internal structure of aerogels consists of a three-dimensional structure of primary particles which fuse to one another in a disordered manner during the sol-gel synthesis. The cavities present between the particles form the pores.

It is known that hydrogels, especially silica hydrogels, which can be produced by acidifying waterglass, can be dried under supercritical conditions to form microporous, three-dimensionally crosslinked products. Such a product obtained by supercritical drying, in the case of gels, is called aerogel. The supercritical drying completely or substantially eliminates the interfacial tension of the fluid present in the microporous, three-dimensionally crosslinked gel. The aim here is to substantially avoid shrinkage of the microporous, three-dimensionally crosslinked gel in the course of drying, since characteristic properties of the microporous, three-dimensionally crosslinked gels are entirely or partly lost in the course of shrinkage. Unlike the case of conventional drying with no particular provisions, in which the gels suffer a great contraction in volume and form xerogels, drying close to the critical point thus results only in a small contraction in volume (less than 15% by volume).

The prior art for production of aerogels by means of supercritical drying is described, for example, in detail in Reviews in Chemical Engineering, Volume 5, No. 1-4, p. 157-198 (1988), in which the pioneering studies by Kistler are also mentioned.

WO-A-95 06 617 relates to hydrophobic silica aerogels which are obtainable by reacting a waterglass solution with an acid at a pH of 7.5 to 11, substantially removing ionic constituents from the hydrogel formed by washing with water or dilute aqueous solutions of inorganic bases while maintaining the pH of the hydrogel within the range from 7.5 to 11, displacing the aqueous phase present in the hydrogel by means of an alcohol and then supercritically drying the resulting alcogel.

WO-A-94 25 149 discloses first treating a gel with a hydrophobizing agent before drying it. The gel obtained as a result can be dried under subcritical conditions without causing any significant contraction in volume.

In the production of aerogels, alkoxy metallates such as tetraethyl orthosilicate or titanium tetraisopropoxide are also used very frequently as raw materials. This has the advantage that no salts, which would have to be removed subsequently, are obtained in the production of the gel. However, a great disadvantage is that alkoxy metallates are very expensive. In this context, the person skilled in the art is aware that the mechanism of sol-gel formation in the case of alkoxy metallates is fundamentally different from that of the soluble salts of an acidic or amphoteric oxygen-containing molecular anion, for instance sodium silicate (C. Jeffrey Brinker, George W. Scherer “Sol-Gel Science: The Physics and Chemistry of Sol-Gel Processing” Academic Press, 1990, page 97ff). According to the amount of water added, alkoxy metallates first form catenated structures with a low level of branching, which crosslink at a later stage. In contrast, for example, silica produced from sodium silicate and an acid polymerizes directly to give particles which become larger as a result of further polymerization and thus form the primary particles.

Aerogels, especially based on silicon dioxide, are already being used in exterior insulation finishing systems due to their very good insulating properties and have the advantage that they lead to a much smaller increase in width of the wall for the same insulation performance. A typical value for the thermal conductivity of silicon dioxide aerogels in air at standard pressure is between 0.017 and 0.021 W/(m·K). The differences in the thermal conductivity of the silicon dioxide aerogels are determined essentially by the difference in size of the pores according to the production process, which is in the range from 10 to 100 nm.

In order to produce aerogels at minimum expense on the industrial scale, suitable raw materials are especially soluble salts of acidic or amphoteric oxygen-containing molecular anions, which may especially be alkali metal silicates, which are reacted with organic or inorganic acids to form the hydrogel. Especially on the industrial scale, however, it is difficult to obtain, from these favourable raw materials, hydrogels and hence also aerogels with a uniform primary particle size and, resulting from this, uniform pore diameter, and hence also to achieve optimal thermal conductivities.

In order to obtain hydrogels with uniform pore diameters, DE 195 40 480 discloses spraying aqueous sodium silicate and an acid, for example sulphuric acid, separately from one another and mixing them with one another, and then adjusting the resulting mixture to the desired pH by means of further addition of acid. However, a disadvantage of this process is that the aim of a very substantially uniform primary particle size is not achieved since rapid homogeneous mixing of the feedstocks cannot be achieved by the process.

WO-A-99 33 554 discloses a process for producing hydrogels, in which sodium waterglass and hydrochloric acid are introduced into a mixing chamber under pressure to mix them, and then sprayed through mixing nozzles. As a result, essentially spherical gel particles can be produced.

A significant disadvantage of this process is the lack of self-cleaning of the mixing nozzle. Thus, product deposits can lead to the constriction and ultimately to the occlusion of the nozzle, and limit the stability and the continuity of the production process. The mixing nozzle also has to be cleaned in a costly and inconvenient manner at each stoppage of the process. Furthermore, high mechanical stresses arise in the course of spraying, which have an adverse effect on the growth of the primary particles.

It is therefore an object of the present invention to provide a procedurally flexible and economically viable process for producing hydrogel based on a soluble salt of an acidic or amphoteric oxygen-containing molecular anion, which ensures the production of a hydrogel with uniform primary particle size and, resulting from this, uniform pore diameter.

This object was achieved by a process for producing a hydrogel, which is performed in a reactor which has
α) a body A which rotates about an axis of rotation and
β) a metering system,
by
a) i) applying a component comprising at least one soluble salt of an acidic or amphoteric oxygen-containing molecular anion and
   ii) a component comprising a precipitant with the aid of the metering system to the surface of the rotating body A, such that a mixture of components i) and ii) flows over the surface of the rotating body A to an outer region of the surface of the rotating body A,
b) and the mixture leaves the surface, and
the pH of the mixture after leaving the surface of the body A is between 2 and 12.

It has been found that, surprisingly, the process according to the invention not only achieves all objects stated, but also enables very simple control of the primary particle size.

The at least one acidic or amphoteric oxygen-containing molecular anion is preferably one based on aluminium, silicon, phosphorus, tin, antimony, titanium, chromium, molybdenum, tungsten, lead, bismuth, zirconium, hafnium, vanadium, niobium, tantalum, boron, arsenic, manganese, rhenium, zinc, germanium, yttrium, berylium and copper.

In a particularly preferred embodiment, the salt of the acidic or amphoteric oxygen-containing molecular anion is at least one compound from the group of alkali metal silicate, alkali metal titanate, alkali metal aluminate and alkali metal phosphate, more particularly, the cation may be at least one from the group of sodium, potassium and ammonium. In a particularly preferred embodiment, the salt of the acidic or amphoteric oxygen-containing molercular anion is sodium silicate or potassium silicate.

The precipitant selected may preferably be at least one from the group of organic acid, inorganic acid and salt of a polyvalent cation of an organic or inorganic acid. Among the organic acids, preference is given to acetic acid, citric acid, trifluoroacetic acid, trichloroacetic acid, carbonic acid and methanesulphonic acid, and the organic acid may especially be acetic acid. The inorganic acids used may, for example, be hydrochloric acid, sulphuric acid, phosphoric acid, boric acid and nitric acid, preference being given especially to sulphuric acid. The salt of a polyvalent cation of an organic or inorganic acid may especially be aluminium chloride, calcium chloride and aluminium sulphate.

The pH of the mixture of components i) and ii) after leaving the surface plays an important role with regard to the rate of hydrogel formation. For example, in the reaction at room temperature of alkali metal silicate with organic or inorganic acids, hydrogel formation at pH 8 to 9 generally takes in the range from seconds to a few minutes, while in the pH range from 2 to 3, hydrogel formation takes hours to days. In the context of the present invention, the pH of the mixture of components i) and ii) after leaving the surface may have a value between 2.5 and 8, preferably between 3.5 and 7 and more preferably between 4 and 5. The pH can also directly influence the size of the primary particles. For example, the primary particles in the case of hydrogel formation on the basis of silica, according to the pH selected, may especially be between 2 and 150 nm. Low pH values lead to smaller primary particles.

It is also possible to influence the rate of hydrogel formation and the primary particle size via the temperature of components i) and ii) used. More particularly, the temperature of the feedstocks is between 10 and 80° C., especially between 15 and 30° C.

In addition, the temperature of the rotating body A, especially of the surface facing the components applied, can be varied within wide ranges and depends on the components used, on the residence time on the body A, and on the desired primary particle size. The temperature of the rotating body is preferably between 5 and 150° C., especially between 15 and 70° C. and more preferably between 20 and 50° C. The components applied to the body A and/or the rotating body A can be heated, for example, electrically, with a heat carrier fluid, with steam, with a laser, with microwave radiation, ultrasound or by means of infrared radiation.

The rotating body A may have the shape of a disc, vase, ring or sphere, and a horizontal rotary disc, or one deviating by up to 45° from the horizontal, is considered to be preferable. Normally, the body A has a diameter of 0.02 m to 3.0 m, preferably 0.10 m to 2.0 m and more preferably from 0.20 m to 1.0 m. The surface may be smooth, corrugated and/or concave or convex, or may have, for example, recesses in the form of grooves or spirals, which influence the mixing and the residence time of the reaction mixture. The body A may preferably be manufactured from metal, glass, plastic or a ceramic. Appropriately, the body A is installed in a container which is stable with respect to the conditions of the process according to the invention. In a preferred embodiment, the rotating body A is in the form of a rotary disc.

The speed of rotation of the body A and the metering rates of the components are variable. Typically, the speed of rotation in revolutions per minute is 1 to 20 000, preferably 100 to 5000 and more preferably 200 to 2000. The volume of the reaction mixture present on the rotating body A per unit area of the surface is typically 0.01 to 20 ml/dm², preferably 0.1 to 10 ml/dm², more preferably 1.0 to 5.0 ml/dm². It is considered to be preferable that the mixture of components i) and ii) on the surface of the rotating body A is in the form of a film which has an average thickness between 1 μm and 2.0 mm, preferably between 60 and 1000 μm, more preferably between 100 and 500 μm.

The mean residence time (mean frequency of the residence time spectrum) of the components depends upon factors including the size of the surface, the type of the compounds, the temperature of the surface and the speed of rotation of the rotating body A. The preferred average residence time of the mixture of components i) and ii) on the surface of the rotating body is between 0.01 and 100 seconds, more preferably between 0.1 and 10 seconds, especially 0.5 and 3 seconds, and is thus considered to be extremely short.

In a further embodiment of the invention, the surface of the body A extends to further rotating bodies, such that the reaction mixture passes from the surface of the rotating body A to the surface of at least one further rotating body. The further rotating bodies appropriately correspond to the body A. Typically, body A in that case “feeds” the further bodies with the reaction mixture. The reaction mixture leaves this at least one further body, and is collected.

A preferred embodiment of the invention envisages that the rotating body A is in the form of a rotary disc, in which case the starting components i) and ii) are applied individually and/or as a mixture, preferably continuously, to the rotary disc with the aid of a metering system. In a particular embodiment, a component iii) comprising a hydrophobizing agent can additionally be applied to the surface of the rotating body A with the aid of the metering system. In order to obtain a very substantially uniform primary particle size, the components can preferably be metered onto the body A such that mixing of components i) and ii) takes place at the point of maximum shearing action. The shearing action depends on the geometry of the body A and can be determined easily by the person skilled in the art. In a further embodiment, the components can be metered in an inner region of the rotary disc. An inner region of the rotary disc is understood to mean a distance of 35% of the radius proceeding from the centred axis of rotation.

It is considered to be especially preferable that the rotary disc is that of a spinning-disc reactor, such reactors being described in detail, for example, in documents WO00/48728, WO00/48729, WO00/48730, WO00/48731 and WO00/48732.

The throughput of the preferably continuous process can be regulated via the regulation of the metering of components i), ii) and optionally of the hydrophobizing agent iii). The throughput can be regulated by means of electronically actuable or manually operable outlet valves or regulating valves. In that case, the pumps, pressure lines or suction lines must convey not only against the viscosity of the reactants, but also against a particular constant, freely adjustable pressure of the installed regulating valve. This method of flow regulation is particularly preferred.

Components i) and ii) can be applied individually and/or as a mixture to the rotating body A. The metering system described enables very variable addition of components i), ii) and optionally of the hydrophobizing agent iii) at different positions of the rotating body A. A portion or the entirety of components i) and ii) can, however, also be premixed and only then applied by means of the metering system to the surface of the rotating body A. Preferably, components i) and ii), however, are applied individually to the rotating body A.

According to the process variant, the reaction product can be contacted directly with the hydrophobizing agent iii) on the rotating body A, or first collected and then introduced with the hydrophobizing agent iii) into a preferably continuous apparatus. The hydrophobizing agent iii) in both variants can preferably be introduced continuously by means of a metering system.

In an alternative preferred embodiment, the hydrogel formed from components i) and ii) is first subjected to a solvent exchange against an organic solvent, especially an alcohol, and the hydrophobizing agent iii) is subsequently contacted with the resulting gel.

The product obtained by the process according to the invention can be treated in various ways. For this purpose, the mixture of components i) and ii) and optionally iii) can be collected after leaving the surface of the body A and subjected to an ageing process. In this case, the resulting mixture is especially suitable for production of hydrogels in the form of monoliths or particle suspensions.

In a preferred embodiment, the mixture can be stored at temperatures of 10 to 80° C., preferably 25-50° C., during the ageing process, such that the silica-containing hydrogel is obtained in the form of a monolith. The shape of the monoliths in this context can be selected virtually freely and is determined by the shape of the vessel in which the storage is conducted.

In a further preferred embodiment, the mixture during the ageing process can be added at temperatures of 10 to 80° C., preferably 25-50° C., to an alkaline solution while stirring, such that the hydrogel is obtained in the form of a particle suspension. The alkaline solution preferably has a pH of 11.5, for which ammonia solution is suitable. The particles in this case especially have a mean particle diameter between 120 and 460 nm (1 and 10 μm after the drying). The production of the particle suspension can also be performed continuously, in which case possible apparatuses are especially a stirred tank cascade or a static mixer.

The hydrogels obtained by the process according to the invention are especially suitable for production of aerogels. In this context, it is possible to use all processes known to those skilled in the art for production of aerogels from hydrogels. More particularly, the hydrogel, optionally after exchange of the water for an organic solvent such as alcohol or hexane, can be hydrophobized. The subsequent drying can then be effected at standard pressure.

The present invention will be described in detail hereinafter with reference to working examples.

### EXAMPLES

The patent examples which follow were performed on a rotating body A which is configured as a smooth disc and consists of copper, the surface having been chromium-plated. The disc is on an axis and is surrounded by a metallic housing and has a diameter of 20 cm. The disc is heated from the inside with a heat carrier oil. Comparable reactors are also described in detail in documents WO00/48728, WO00/48729, WO00/48730, WO00/48731 and WO00/48732.

Production of silica hydrogel with variation of the concentration of the starting compounds:

### Example 1

A 30% by weight waterglass solution is metered at a temperature of 20° C. onto the centre of the disc, with a flow of 93.75 ml/min. At the same time, a 30% by weight acetic acid solution at a temperature of 20° C. is metered onto the disc at a radial distance of one centimetre from the centre, with a flow of 112.5 ml/min. The disc rotates with a speed of 500 revolutions per minute and is at a controlled temperature of 23° C. The mixture is collected after leaving the disc.

pH of the resulting mixture: 4.7
Mean primary particle size: 57.4 nm

### Example 2

A 20% by weight waterglass solution is metered at a temperature of 20° C. onto the centre of the disc, with a flow of 93.75 ml/min. At the same time, a 20% by weight acetic acid solution at a temperature of 20° C. is metered onto the disc at a radial distance of one centimetre from the centre, with a flow of 112.5 ml/min. The disc rotates with a speed of 500 revolutions per minute and is at a controlled temperature of 23° C. The mixture is collected after leaving the disc.

pH of the resulting mixture: 4.7
Gel formation time: 45 minutes
Mean primary particle size: 46.5 nm

### Example 3

A 10% by weight waterglass solution is metered at a temperature of 20° C. onto the centre of the disc, with a flow of 93.75 ml/min. At the same time, a 10% by weight acetic acid solution at a temperature of 20° C. is metered onto the disc at a radial distance of one centimetre from the centre, with a flow of 112.5 ml/min. The disc rotates with a speed of 500 revolutions per minute and is at a controlled temperature of 23° C. The mixture is collected after leaving the disc.

pH of the resulting mixture: 4.7
Mean primary particle size: 36.6 nm

### Example 4

A 5% by weight waterglass solution is metered at a temperature of 20° C. onto the centre of the disc, with a flow of 93.75 ml/min. At the same time, a 5% by weight acetic acid solution at a temperature of 20° C. is metered onto the disc at a radial distance of one centimetre from the centre, with a flow of 112.5 ml/min. The disc rotates with a speed of 500 revolutions per minute and is at a controlled temperature of 23° C. The mixture is collected after leaving the disc.

pH of the resulting mixture: 4.7
Mean primary particle size: 28.1 nm

Production of silica hydrogel with variation of the disc speed:

### Example 5

A 20% by weight waterglass solution is metered at a temperature of 20° C. onto the centre of the disc, with a flow of 93.75 ml/min. At the same time, a 20% by weight acetic acid solution at a temperature of 20° C. is metered onto the disc at a radial distance of one centimetre from the centre, with a flow of 112.5 ml/min. The disc rotates with a speed of 500 revolutions per minute and is at a controlled temperature of 23° C. The mixture is collected after leaving the disc.

pH of the resulting mixture: 4.7
Mean primary particle size: 34.8 nm

Production of silica hydrogel with variation of the flow:

### Example 6

A 20% by weight waterglass solution is metered at a temperature of 20° C. onto the centre of the disc, with a flow of 281.25 ml/min. At the same time, a 20% by weight acetic acid solution at a temperature of 20° C. is metered onto the disc at a radial distance of one centimetre from the centre, with a flow of 337.5 ml/min. The disc rotates with a speed of 1000 revolutions per minute and is at a controlled temperature of 23° C. The mixture is collected after leaving the disc.

pH of the resulting mixture: 4.7
Mean primary particle size: 40.2 nm

Production of silica hydrogel with variation of the disc temperature:

### Example 7

A 20% by weight waterglass solution is metered at a temperature of 20° C. onto the centre of the disc, with a flow of 93.75 ml/min. At the same time, a 20% by weight acetic acid solution at a temperature of 20° C. is metered onto the disc at a radial distance of one centimetre from the centre, with a flow of 112.5 ml/min. The disc rotates with a speed of 500 revolutions per minute and is at a controlled temperature of 50° C. The mixture is collected after leaving the disc.

pH of the resulting mixture: 4.7
Gel formation time: 12 min

The size of the primary particles, after the drying of the samples, was determined with a field-emission scanning electron microscope (LEO 1525 Gemini).

Before drying, all samples of the resulting liquid aquagel were stirred into 500 ml of a 2.5% ammonia solution. The resulting aerogel flakes were washed to free them of salt and ammonia (6 times with 750 ml of H₂O) down to a conductivity of approx. 2 ms. Subsequently, they were washed three times with 250 ml of isopropyl alcohol and the gel was modified with hexamethyldisilazane (5% by weight of the filtercake=8.2 g) and made up again with 750 ml of isopropyl alcohol.

The drying of the gel was performed on a spinning-disc reactor, which was also used for the production of the aquagel. The disc of the spinning-disc reactor is smooth and consists of copper, the surface having been chromium-plated. The disc is on an axis and is surrounded by a metallic housing, has a diameter of 20 cm and is heated from the inside with a heat carrier oil. Comparable reactors are also described in detail in documents WO00/48728, WO00/48729, WO00/48730, WO00/48731 and WO00/48732.

The following settings were selected for the drying of the aquagel with the spinning-disc reactor:

| Speed | Disc | Reactor wall |
|---|---|---|
| rpm | ° C. | ° C. |
| 1000 | 200 | 80 |

1. Process for producing a hydrogel, characterized in that it is performed in a reactor which has
α) a body A which rotates about an axis of rotation and
β) a metering system,
by
a) i) applying a component comprising at least one soluble salt of an acidic or amphoteric oxygen-containing molecular anion and
ii) a component comprising a precipitant
with the aid of the metering system to the surface of the rotating body A, such that a mixture of components i) and ii) flows over the surface of the rotating body A to an outer region of the surface of the rotating body A,
b) and the mixture leaves the surface, and
the pH of the mixture after leaving the surface of the body A is between 2 and 12.

2. Process according to claim 1, characterized in that the rotating body A is in the form of a rotary disc.

3. Process according to claim 1, characterized in that the mixture of components i) and ii) on the surface of the rotating body A is in the form of a film which has an average thickness between 1 μm and 2 mm.

4. Process according to claim 1, characterized in that the average residence time of the mixture of components i) and ii) on the surface of the rotating body is between 0.01 and 100 seconds.

5. Process according to claim 1, characterized in that the temperature of the rotating body is between 5 and 150° C.

6. Process according to claim 1, characterized in that the at least one acidic or amphoteric oxygen-containing molecular anion is one based on aluminium, silicon, phosphorus, tin, antimony, titanium, chromium, molybdenum, tungsten, lead, bismuth, zirconium, hafnium, vanadium, niobium, tantalum, boron, arsenic, manganese, rhenium, zinc, germanium, yttrium, berylium or copper.

7. Process according to claim 1, characterized in that the salt of the acidic or amphoteric oxygen-containing molecular anion is at least one compound from the group of alkali metal silicate, alkali metal titanate, alkali metal aluminate and alkali metal phosphate.

8. Process according to claim 1, characterized in that the precipitant is at least one from the group of organic acid, inorganic acid and salt of a polyvalent cation of an organic or inorganic acid.

9. Process according to claim 1, characterized in that the mixture of components i) and ii) after leaving the surface has a pH between 2.5 and 8.

10. Process according to claim 1, characterized in that components i) and ii) are applied individually and/or as a mixture to the rotating body A.

11. Process according to claim 1, characterized in that
iii) a component comprising a hydrophobizing agent is applied to the surface of the rotating body A with the aid of the metering system.

12. Process according to claim 1, characterized in that the mixture of components i) and ii) and optionally iii) is collected after leaving the surface of the body A and subjected to an ageing process.

13. Process according to claim 12, characterized in that the mixture is stored at temperatures of 10 to 80° C. during the ageing process, such that the silica-containing hydrogel is obtained in the form of a monolith.

14. Process according to claim 12, characterized in that the mixture during the ageing process is added at temperatures of 10 to 80° C. to an alkaline solution while stirring, such that the hydrogel is obtained in the form of a particle suspension.

15. (canceled)
